(19) United States
(12) Patent Application Publication
(10) Pub. No.: US 2015/0357812 A1
(43) Pub. Date: Dec. 10, 2015

(54) ELECTRICAL SYSTEM HAVING GALVANIC ISOLATION

(71) Applicant: Electro-Motive Diesel, Inc., LaGrange, IL (US)

(72) Inventor: James F. WIEMEYER, Homer Glen, IL (US)

(73) Assignee: Caterpillar Inc

(21) Appl. No.: 14/298,776

(22) Filed: Jun. 6, 2014

(51) Int. Cl. H02H 9/00; H02H 7/08

(52) U.S. Cl. CPC H02H 9/00; H02H 7/08

(57) ABSTRACT

The present disclosure is directed to an electrical system. The electrical system may include a first device having a first chassis and a first port therein. The electrical system may further include a second device having a second chassis and a second port therein. The first device and the second device may be connected by a cable through the first port and the second port. The second chassis may be conductively connected to earth ground. The pin on the second port may be connected to isolated ground in the second device through an electrostatic discharge protection device, and the isolated ground may be connected to the second chassis through a set of capacitors.

### TECHNICAL FIELD

The present disclosure relates generally to electrical systems, and more particularly to electrical systems having galvanically isolated input-output circuitry.

### BACKGROUND

Traditional locomotives are known to use several on-board electrical systems that have input-output (“i/o”) circuitry to input and output signals. It is well known to have galvanic (voltage) isolation for each data port to tolerate and separate different ground potentials between remotely mounted devices. The galvanic isolation greatly reduces or eliminates potential ground loops from interfering with communication signals between the remote devices. In addition to eliminating ground loops, galvanic isolation of a devices' i/o circuitry allows the device to withstand application of high potentials (HIPOT) between the i/o circuit and the grounded device chassis. HIPOT voltage ratings commonly range from 500V to 1500V, although certain devices may have a requirement to withstand even higher HIPOT voltages, for high intended voltage application in normal use.

Another desirable aspect of i/o circuitry includes electromagnetic shielding of the data communication conductors inside the device and of the conductors contained within the external data cables that carry communication signals between the remote devices. Such shielding, implemented wisely, increases the device's immunity to impinging radiated electromagnetic interference and greatly decreases a device's radiated emissions as well.

Another desirable aspect of electronic devices is resilience to electrostatic discharge (ESD) events. ESD events may utilize voltages up to 20 kV. ESD protection may be especially important for devices that normally require human intervention during wiring installation and servicing. Common methods of ESD protection include transient protection diodes, metal oxide varistors (MOVs) and components containing spark gaps.

However, galvanic isolation of i/o circuitry presents an apparent conflict with respect to ESD protection methods. For example, HIPOT testing of circuitry that includes the above-noted ESD protection components could permanently damage the ESD protection components. Furthermore, incorporation of the ESD protection components could also defeat the galvanic isolation measures.

U.S. Publication No. 2012/0258678 (“the '678 publication”) discloses a technique to reduce a common-mode interference signal between parallel coupled cables of a power adapter apparatus and a tuner apparatus in order to provide an enhanced cable that has both a reception antenna and a conductive path for electrical power. While the '678 publication may reduce common-mode interference signals between an antenna and a power cable, the '678 publication does not provide a solution such that the benefits of electromagnetic shielding, galvanic isolation, and ESD protection can be reaped for the same device.

The presently disclosed electrical system is directed to overcoming one or more of the problems set forth above and/or other problems in the art.

### SUMMARY

In accordance with one aspect, the present disclosure is directed to an electrical system. The electrical system may include a first device having a first chassis and a first port therein. The electrical system may further include a second device having a second chassis and a second port therein. The first device and the second device may be connected by a cable through the first port and the second port. The second chassis may be conductively connected to earth ground. The pin on the second port may be connected to isolated ground in the second device through an electrostatic discharge protection device, and the isolated ground may be connected to the second chassis through a set of capacitors.

According to another aspect, the present disclosure is directed to a device. The device may include a chassis having a port therein and a circuit board. The chassis may be conductively connected to earth ground. A pin on the port may be connected to isolated ground on the circuit board through an electrostatic discharge protection device, and the isolated ground may be connected to the chassis through a set of capacitors.

### BRIEF DESCRIPTION OF THE DRAWINGS

FIG. 1 illustrates a pictorial view of an exemplary consist of two locomotives.

FIG. 2 illustrates an exemplary electrical system.

FIG. 3 illustrates an exemplary circuit board configuration for a device of the electrical system of FIG. 2.

### DETAILED DESCRIPTION

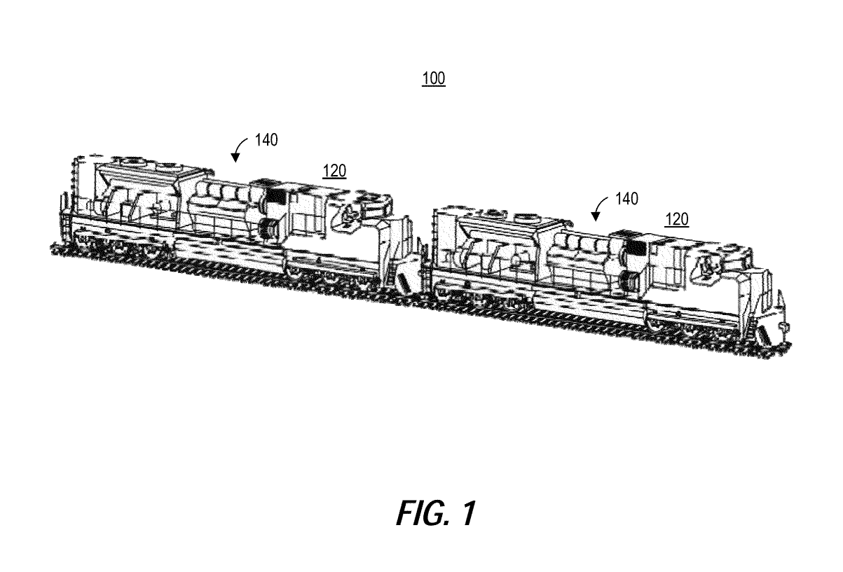

FIG. 1 illustrates a consist 100 comprising a plurality of locomotives 120, the plurality including at least a first and a last locomotive 120. Each locomotive 120 may include a locomotive engine 140. In one embodiment, locomotive engine 140 may comprise a uniflow two-stroke diesel engine system. Those skilled in the art will also appreciate that each locomotive 120 may also, for example, include an operator cab (not shown), facilities used to house electronics, such as electronics lockers (not shown), protective housings for locomotive engine 140 (not shown), and a generator used in conjunction with locomotive engine 140 (not shown).

While not shown in FIG. 1, consist 100 may comprise more than two locomotives 120. Additionally, consist 100 may also comprise a variety of other railroad cars, such as freight cars or passenger cars, and may employ different arrangements of the cars and locomotives to suit the particular use of consist 100. In an embodiment, the locomotives within consist 100 communicate with each other through, for example, wired or wireless connections between the locomotives. Particular examples of such connections may include, but are not limited to, a wired Ethernet network connection, a wireless network connection, a wireless radio connection, a wired serial or parallel data communication connection, or other such general communication pathway that operatively links control and communication systems on-board respective locomotives of a consist.

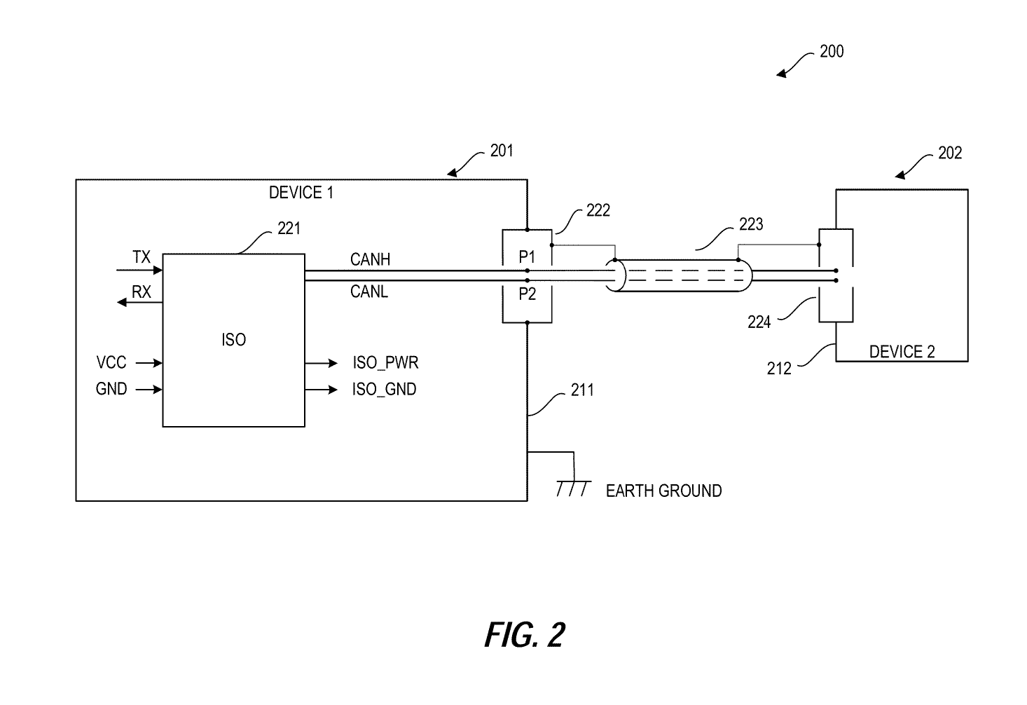

FIG. 2 illustrates an electrical system 200 that may be found in various places, including locomotive 120. Electrical system 200 may include two devices 201 and 202 electrically connected to each other through a cable 223. Each device 201 and 202 may have a chassis 211 and 212, respectively that acts as a metallic shield or covering for the components of devices 201 and 202. Each of devices 201 and 202 may include a port (e.g., connector 222 in device 201 and connector 224 in device 202) that acts as input-output interfaces for devices 201 and 202. For example, cable 223 may couple to connectors 222 and 224. Connectors 222 and 224 may be any connectors known in the art. For example, connectors 222 and 224 may be a 9 pin connector such as a DB9 connector. Exemplarily, connectors 222 and 224 may have shrouds (not shown) that conductively connect connectors 222 and 224 to chassis 211 and 212, respectively. Exemplarily, chassis 211 and 212 may be connected to earth ground.

Cable 223 may carry data between devices 201 and 202, and may contain a conductive shield that connects to the chassis 211 or 212 through the connector shrouds and the cable connectors (not shown) that couple with connectors 222, 224. Once a 360° connection is formed between the cable connectors and connectors 222, 224, electrical system 200 can be said to have been covered by a single conductive, shielding surface. In other words, the entire system 200 can be said to have a single conductive skin, which provides electromagnetic shielding.

Inside each device 201 and 202, there may be additional circuitry that operates on the data communicated by 223. For example, in device 201, there is shown an isolation circuitry 221 that is coupled to connector 222 and communicates data received or transmitted by cable 223. As an example, line CANH from isolation circuitry 221 may be connected to pin P1 of connector 222. Similarly, line CANL from isolation circuitry 221 may be connected to pin P2 of connector 222.

Isolation circuitry 221 may isolate signals between different parts of device 201. For example, the signal communicated on the TX line causes data to undergo transmission, in differential signal form (CANH-CANL), from device 201 onto the data cable 223. Similar, the RX line responds to differential data (CANH-CANL) incoming from data cable 223 and through the isolation circuitry 221. Additionally, isolation circuitry may also isolate the power and ground planes between different parts of device 201. As shown in FIG. 2, device 201's internal power supply VCC may be isolated and output as ISO_PWR. Similarly, the ground plane (GND) may be isolated and output as isolated ground (ISO_GND). It will be understood that isolation circuitry 221 may include different circuitry for isolating different signals. For example, a transformer may be used to isolate the power and ground planes. Exemplarily, an optoisolator integrated circuit may be used to isolate CANH and CANL from TX and RX signals. In another embodiment, a transformer may be used to isolate CANH and CANL from TX and RX signals.

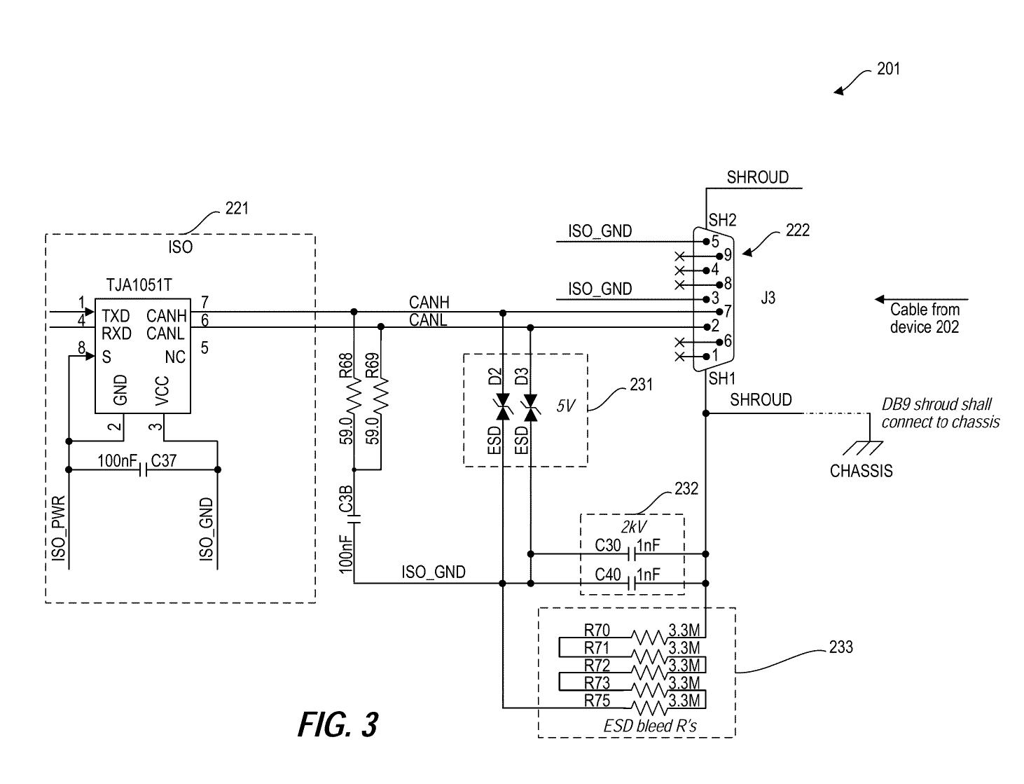

FIG. 2 generally illustrates the concepts of providing a conductive skin around the electrical system and providing internal galvanic (voltage) isolation within a device. FIG. 3 now further describes exemplary ESD protection mechanism for the i/o circuitry of device 201. It will be understood that similar ESD protection mechanism may also be provided for device 202.

In FIG. 3, connector 222 is illustrated as a 9-pin DB9 connector. Cable 223 (not shown) from device 202 may couple with connector 222. The DB9 connector may include a metallic shroud that electrically connects both to chassis 211 and to a circuit board that houses isolation circuitry 221, ESD protection device 231, a set of capacitors 232, and resistive network 233. Further, pins 7 and 2 of connector 222 may communicate signals received through cable 223 to isolation circuitry 221 via the CANH and CANL lines. In FIG. 3, VCC and GND in FIG. 2 may be set as 5V and 0V, respectively. It will be understood that 5V and 0V are only exemplary voltage levels and any other voltage level may be set for VCC and GND. The isolated power and ground planes are denoted as ISO_PWR and ISO_GND, respectively, in FIG. 3.

An ESD protection device 231 may be connected to pins 7 and 2 to provide ESD protection. The ESD protection device 231 exemplarily includes zener diodes in this embodiment. While zener diodes have been used in this embodiment, it will be understood that other ESD protection devices such as metal oxide varistors or a device containing a spark gap may be used in place of the zener diodes. In FIG. 3, the zener diodes connect pins 7 and 2 to isolated ground (ISO_GND). Additionally, the circuit board may include a set of high voltage capacitors 232 connected in parallel with a resistive network 233 between the chassis 211 (which is at earth ground) and isolated ground. The set of high voltage capacitors 232 may include one or more capacitors such that the total capacitance is at least 1 nF. The resistive network 233 may include one or more resistors connected in series such that they are able to discharge the capacitors 232. Exemplarily, resistive network 233 may include five resistors connected in series where the resistance of each resistor is 3.3 Mohms. Next, operation of the ESD protection mechanism will be explained.

Assume that an ESD event occurs during installation or wiring of cable 223 with connector 222. Specifically, assume that an ESD event occurs with respect to pin 7. If a 10 kV voltage is applied to pin 7 during the ESD event, the total charge that is transferred may be calculated by assuming the capacitance of the human operator to be 150 pF. The zener diode connected to pin 7 will conduct that charge, which ultimately charges the capacitors 232 to a voltage below 1 kV because of the higher capacitance value (greater than 1 nF) of the capacitors 232. The 1 kV or less voltage value now results in a tolerable value for the isolated circuitry. Moreover, the multiple series resistors in resistive network 233 may withstand a higher voltage than a single resistor and provide a bleed discharge path for the ESD-interception capacitors 232. Such a bleed discharge path provides resiliency to repeated ESD events, by discharging the capacitors 232 within approximately 100 milliseconds.

### INDUSTRIAL APPLICABILITY

The disclosed electrical system and circuitry may provide a solution such that the benefits of electromagnetic shielding, galvanic isolation, and ESD protection can be reaped for the same device. The ESD interception capacitors may, for example, load down 10 kV ESD events to a tolerable level of less than 1 kV. Accordingly, the i/o circuitry tolerates HIPOT testing and ESD events.

Further, the circuit board may provide a return path for common mode currents contained between the data signal conductors (e.g., CANH and CANL) and the chassis through the capacitors 232 to isolated ground. Moreover, the entire system can be enveloped in a conductive skin to provide RF immunity and reduction of RF emissions. The above advantages may not be provided by conventional techniques. Moreover, it will be understood that the above disclosed techniques are applicable to other interface types such as RS232, RS422, RS 485, and Ethernet.

It will be apparent to those skilled in the art that various modifications and variations can be made to the disclosed techniques. Other embodiments will be apparent to those skilled in the art from consideration of the specification and practice of the disclosed techniques. It is intended that the specification and examples be considered as exemplary only, with a true scope being indicated by the following claims and their equivalents.

What is claimed is:

1. An electrical system comprising:
a first device having a first chassis and a first port therein; and
a second device having a second chassis and a second port therein,
wherein:
the first device and the second device are connected by a cable through the first port and the second port,
the second chassis is conductively connected to earth ground,
a pin on the second port is connected to isolated ground in the second device through an electrostatic discharge protection device, and
the isolated ground is connected to the second chassis through a set of capacitors.

2. The electrical system of claim 1, wherein capacitance of the set of capacitors is at least 1 nF.

3. The electrical system of claim 2, wherein the set of capacitors are connected in parallel to a set of resistors through which the set of capacitors can discharge into earth ground.

4. The electrical system of claim 3, wherein the set of resistors includes a series network of more than one resistor.

5. The electrical system of claim 1, wherein the first chassis, the second chassis, and the cable form a single conductive skin.

6. The electrical system of claim 2, wherein the set of capacitors includes two capacitors.

7. The electrical system of claim 1, wherein the electrostatic discharge protection device is a zener diode.

8. The electrical system of claim 1, wherein the electrostatic discharge protection device is a metal oxide varistor or a device containing a spark gap.

9. The electrical system of claim 1, wherein the set of capacitors, the electrostatic discharge protection device, and the isolated ground are provided on a circuit board.

10. The electrical system of claim 9, wherein the isolated ground is a ground plane that is isolated from another ground plane on the circuit board using a transformer.

11. A device comprising:
a chassis having a port therein; and
a circuit board,
wherein:
the chassis is conductively connected to earth ground,
a pin on the port is connected to isolated ground on the circuit board through an electrostatic discharge protection device, and
the isolated ground is connected to the chassis through a set of capacitors.

12. The device of claim 11, wherein capacitance of the set of capacitors is at least 1 nF.

13. The device of claim 12, wherein the set of capacitors are connected in parallel to a set of resistors through which the set of capacitors can discharge into earth ground.

14. The device of claim 13, wherein the set of resistors includes a series network of more than one resistor.

15. The device of claim 12, wherein the set of capacitors includes two capacitors.

16. The device of claim 11, wherein the electrostatic discharge protection device is a zener diode.

17. The device of claim 11, wherein the electrostatic discharge protection device is a metal oxide varistor or a device containing a spark gap.

18. The device of claim 11, wherein the isolated ground is a ground plane that is isolated from another ground plane on the circuit board using a transformer.

19. A locomotive including the electrical system of claim 1.

20. A locomotive including the device of claim 11.
